(19) United States
(12) Patent Application Publication
(10) Pub. No.: US 2009/0205483 A1
(43) Pub. Date: Aug. 20, 2009

(54) MUSIC RECOGNITION METHOD BASED ON HARMONIC FEATURES AND MOBILE ROBOT MOTION GENERATION METHOD USING THE SAME

(76) Inventor: Hyun Soo KIM, Yongin-si (KR)

Correspondence Address: CHA & REITER, LLC, 210 ROUTE 4 EAST STE 103, PARAMUS, NJ, 07652, US

(21) Appl. No.: 12/361,692

(22) Filed: Jan. 29, 2009

(30) Foreign Application Priority Data
Jan. 29, 2008 (KR) 10-2008-0009070

(51) Int. Cl. G10H 1/06

(52) U.S. Cl. 84/622

(57) ABSTRACT

A music recognition method based on harmonic features and a motion generation method for a mobile robot. The music recognition method preferably includes: extracting harmonic peaks from an audio signal of an input song; computing a harmonic feature related to the average of distances between extracted harmonic peaks; and recognizing the input song by harmonic component analysis based on the computed harmonic feature. The motion generation method for a mobile robot includes: extracting a musical feature from an audio signal of an input song; generating an initial musical score after identifying the input song on the basis of the extracted musical feature; generating a final musical score by synchronizing the initial musical score and musical feature together; and generating robot motions or a motion script file by matching a motion pattern of the mobile robot with the final musical score.

### CLAIM OF PRIORITY

This application claims priority from an application entitled “MUSIC RECOGNITION METHOD BASED ON HARMONIC FEATURES AND MOBILE ROBOT MOTION GENERATION METHOD USING THE SAME” filed in the Korean Intellectual Property Office on Jan. 29, 2008 and assigned Ser. No. 10-2008-0009070, the contents of which are incorporated herein by reference in its entirety.

### BACKGROUND OF THE INVENTION

1. Field of the Invention

The present invention relates generally to music recognition and motion generation for a mobile robot. More particularly, the present generation generally relates to a method of music recognition based on harmonic features and a method of motion generation for a mobile robot using the same.

2. Description of the Related Art

Music recognition refers to identification of a particular song by analyzing musical properties of the song while the song is being played. Similar in a way to a human capable of recognizing a song by hearing at least a portion of the song, music recognition enables a music recognition apparatus, such as a computer, to identify a song being played.

Currently, the use of music recognition is limited to providing simple musical information such as file identifier, title, composer, writer, and singer of a song being played.

### SUMMARY OF THE INVENTION

The present invention provides a music recognition method based on harmonic features of a song.

The present invention also provides a method of motion generation using music recognition for a mobile robot.

In accordance with an exemplary embodiment of the present invention, there is provided a music recognition method based on harmonic data, preferably including: converting an audio signal of an input song into a frequency domain representation; extracting first order harmonic peaks from the frequency domain representation, and extracting up to nth order harmonic peaks (with “n” being a natural number greater than or equal to 2) on the basis of the first order harmonic peaks; and computing a harmonic feature of the song related to the average of distances between extracted harmonic peaks of the same order with respect to the first harmonic f₀.

In accordance with yet another exemplary embodiment of the present invention, there is provided a motion generation method based on music recognition for a mobile robot, preferably including: extracting a musical feature from an audio signal of an input song; generating an initial musical score after identifying the input song on the basis of the extracted musical feature; generating a final musical score by synchronizing the initial musical score and musical feature together; and generating robot motions by matching a motion pattern of the mobile robot with the final musical score.

In accordance with still another exemplary embodiment of the present invention, there is provided a motion generation method based on music recognition for a mobile robot, preferably including: extracting a musical feature from an audio signal of an input song; generating an initial musical score after identifying the input song on the basis of the extracted musical feature; generating a final musical score by synchronizing the initial musical score and musical feature together; and creating a motion script file by matching a motion pattern of the mobile robot with the final musical score.

In accordance with even another exemplary embodiment of the present invention, there is provided a motion generation method based on music recognition for a mobile robot, preferably including: extracting a musical feature from an audio signal of an input song; and generating robot motions by matching a motion pattern of the mobile robot with the extracted musical feature.

In an exemplary aspect of the present invention, a harmonic feature for music recognition is preferably produced on the basis of distances between extracted harmonic peaks. The harmonic feature is related to the average of distances between harmonic peaks with respect to the first harmonic, which can be considered as the size of the harmonic of an audio signal, and provides information on the periodicity of the extracted harmonic peaks. Hence, an input song is recognized by analyzing harmonic components on the basis of the harmonic feature.

Music recognition is used preferably for moving a mobile robot, or to provide a mobile robot with a motion script file necessary for moving the mobile robot. The motion script file can be used as a source material for motion generation for another mobile robot. The motion script file can be applied to both a physical mobile robot and a virtual mobile robot implemented using software.

### BRIEF DESCRIPTION OF THE DRAWINGS

The exemplary features and advantages of the present invention will become more apparent to the person of ordinary skill in the art from the following detailed description in conjunction with the accompanying drawings, in which:

FIG. 1 is a block diagram of a music recognition apparatus based on harmonic features according to an exemplary embodiment of the present invention;

FIG. 2 is a graph illustrating an example of harmonic peak extraction;

FIG. 3 is a flowchart illustrating a harmonic feature extracting method for music recognition according to another exemplary embodiment of the present invention;

FIG. 4 is a block diagram of a motion generation apparatus based on music recognition for a mobile robot;

FIGS. 5A to 5C illustrate screen representations of an authoring tool for motion generation;

FIG. 6 is a flowchart illustrating exemplary operation a motion generation method based on music recognition for a mobile robot according to another exemplary embodiment of the present invention; and

FIG. 7 is a flowchart illustrating exemplary operation of a motion generation method for a mobile robot according to another exemplary embodiment of the present invention.

### DETAILED DESCRIPTION

Hereinafter, exemplary embodiments of the MUSIC RECOGNITION METHOD BASED ON HARMONIC FEATURES AND MOBILE ROBOT MOTION GENERATION METHOD according to the present invention are described in detail for illustrative purposes to a person of ordinary skill in the art with reference to the accompanying drawings. The same reference symbols are used throughout the drawings to refer to the same or like parts. Detailed descriptions of well-known functions and structures incorporated herein may be omitted to avoid obscuring the appreciation of the subject matter of the present invention by the person of ordinary skill in the art.

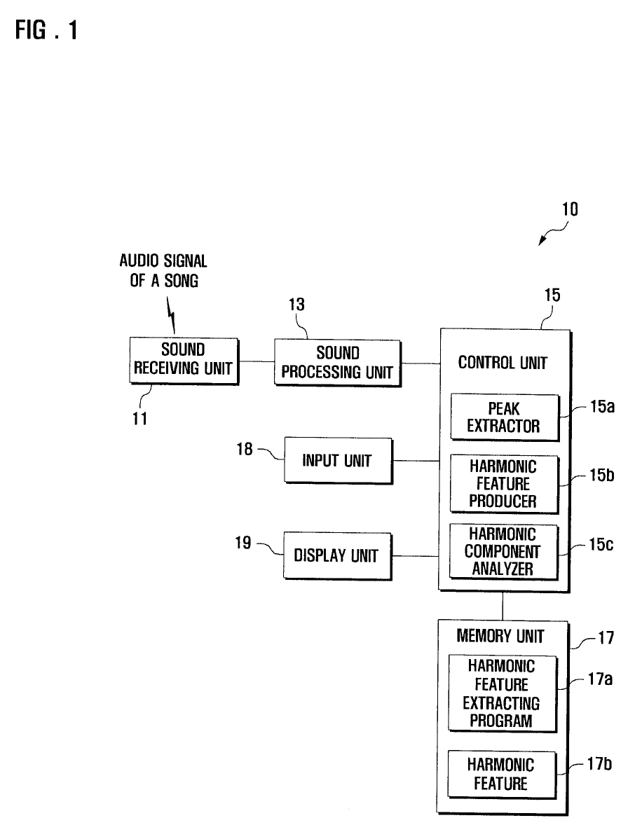

FIG. 1 illustrates a music recognition apparatus 10 based on harmonic features according to an exemplary embodiment of the present invention. The music recognition apparatus 10 as shown in this example preferably includes, a sound receiving unit 11, sound processing unit 13, control unit 15, memory unit 17, input unit 18, and display unit 19.

The music recognition apparatus 10 may comprise, for example, a separate entity or can be installed in a computer or mobile robot.

Still referring to FIG. 1, the sound receiving unit 11 receives an audio signal of a song and outputs the audio signal to the sound processing unit 13. The sound receiving unit 11 receives an audio signal of a song played by a music player such as a cassette player, CD player, MD player, MP3 player, computer, cellular phone, or radio. The sound receiving unit 11 may include, for example, a microphone or audio input terminal. The microphone receives an audio signal from a speaker of a music player. The audio input terminal receives an audio signal from a music player connected through a wired or wireless channel. The audio input terminal and music player can be connected together through an audio cable, or wirelessly through radio frequency communication or short-range communication like Bluetooth.

The sound processing unit 13 converts into a frequency domain representation an audio signal received from the sound receiving unit 11, and outputs the frequency domain representation of the audio signal to the control unit 15. This conversion can be performed using one of, for example, fast Fourier transform (FFT), short-time Fourier transform (STFT), discrete Fourier transform (DFT), and discrete cosine transform (DCT).

The control unit 15 preferably comprises a microprocessor for controlling the overall operation of the music recognition apparatus 10. In particular, the control unit 15 extracts harmonic features from an input audio signal of a song, and identifies the song on the basis of the extracted harmonic features.

The memory unit 17 preferably stores programs necessary for the operation of the music recognition apparatus 10, and data generated from execution of the programs. The memory unit 17 may include one or more of volatile and non-volatile memories. In particular, the memory unit 17 preferably stores a harmonic feature extracting program 17a and harmonic features 17b extracted by the program 17a.

The input unit 18 preferably includes a plurality of keys to manipulate the music recognition apparatus 10, and generates a key signal corresponding to a user-selected key and sends the key signal to the control unit 15. The user can issue a command through the input unit 18 to receive an audio signal through the sound receiving unit 11 or to execute the harmonic feature extracting program 17a. The input unit 18 may include input means such as a mouse, key pad, touch pad, pointing device, and touch screen, and could be a voice activated input.

Still referring to FIG. 1, the display unit 19 displays various menus for functions executed by the music recognition apparatus 10, and information stored in the memory unit 17. The display unit 19 can include, for example a panel of liquid crystal display (LCD) devices and a touch screen. The touch screen enables the display unit 19 to act as a display device and an input device at the same time. Other thin screen technologies may also be used.

In particular, the control unit 15 includes a peak extractor 15a, harmonic feature producer 15b, and harmonic component analyzer 15c.

The peak extractor 15a preferably extracts, for example, from a frequency domain representation of an audio signal derived by the sound processing unit 13, first order harmonic peaks, and extracts up to nth order harmonic peaks (n: natural number greater than 1) on the basis of the first order harmonic peaks. Here, the peak extractor 15a extracts the nth order harmonic peaks from a frequency domain consisting of the n−1th order harmonic peaks.

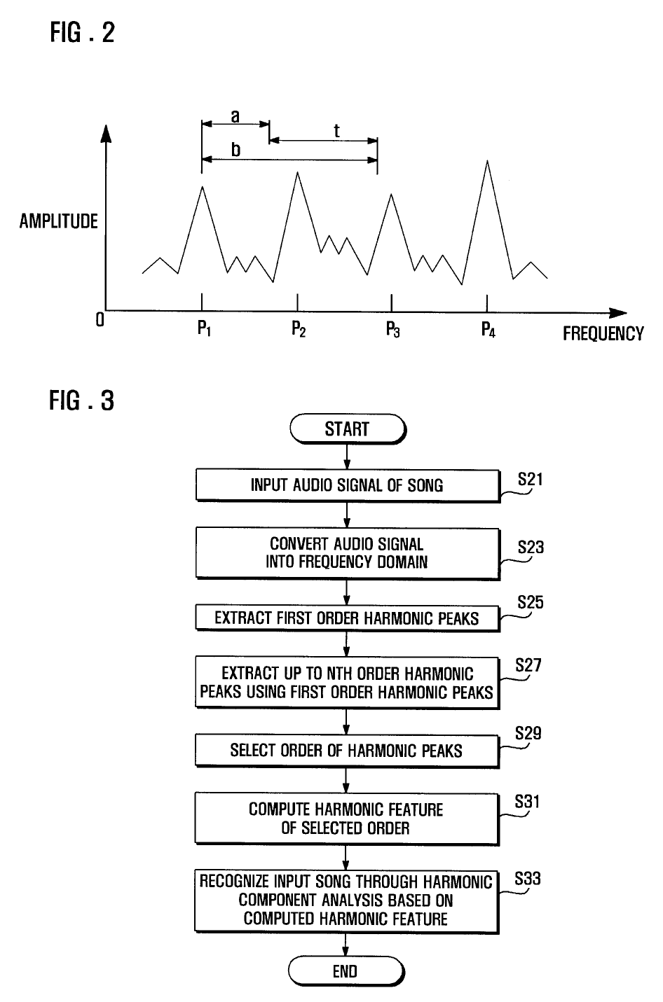

As shown in FIG. 2, the peak extractor 15a may extract first order harmonic peaks in a manner shown in FIG. 2. In the frequency domain obtained by the sound processing unit 13, the peak extractor 15a finds the highest peak within the first search range (t), and selects the highest peak as the first harmonic peak (P₁). The peak extractor 15a finds the highest peak within the second search range (t) starting from a given distance (a) from the end of the first search range, and selects the highest peak as the second harmonic peak (P₂). Likewise, other first order harmonic peaks (P₃ and P₄) are obtained. Here, the search ranges (t) for the first order harmonic peaks are the same in length (t=b−a). Second order harmonic peaks can be extracted from a frequency domain consisting of the first order harmonic peaks in a similar manner. Nth order harmonic peaks can also be extracted by repeating the above procedure.

Higher order harmonic peaks have relatively higher spectrum levels than lower order harmonic peaks. With increasing order, the number of extracted peaks decreases.

Now referring back to FIG. 1, the harmonic feature producer 15b computes a harmonic feature of a song, which is based on distances between extracted harmonic peaks of the same order. The harmonic feature is related to the average of distances between harmonic peaks with respect to the first harmonic f₀. The harmonic feature producer 15b stores the computed harmonic feature 17b in the memory unit 17.

The harmonic feature can be computed, for example, by using Equation 1 or Equation 2. In Equation 2, weights are considered according to amplitudes of extracted harmonic peaks.

$$\frac{1}{N - 1} {\sum }_{k = 1}^{N - 1} {( \frac{{p}_{k + 1} - {p}_{k} - {f}_{0}}{{f}_{0}} )}^{2} , \qquad [ Equation 1 ]$$

where N is the number of total peaks of a given order and pₖ is the kth peak.

$$\frac{1}{N - 1} {\sum }_{k = 1}^{N - 1} {( {A}_{k} )}^{γ} {( \frac{{p}_{k + 1} - {p}_{k} - {f}_{0}}{{f}_{0}} )}^{2} , \qquad [ Equation 2 ]$$

where Aₖ is the amplitude of pₖ and γ is a constant.

The harmonic component analyzer 15c recognizes the input song through harmonic component analysis according to the obtained harmonic feature. That is, the harmonic feature is related to the average of distances between harmonic peaks with respect to the first harmonic f₀, can be considered as the size of the harmonic f₀ of an audio signal, and provides information on the periodicity of extracted harmonic peaks. Hence, the harmonic component analyzer 15c recognizes the input song by analyzing the average distance between harmonic peaks with respect to the harmonic f₀ in the harmonic feature.

The harmonic feature provided by the music recognition apparatus 10 can be used, for example, as harmonic information during the music recognition process.

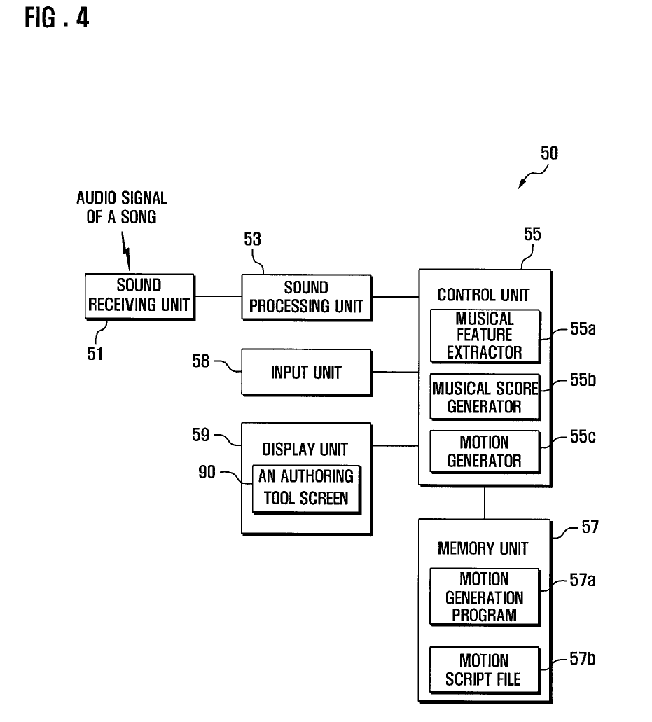

Next, an exemplary music recognition method is described in connection with FIGS. 1 to 3, particularly with reference to the exemplary operation in the flowchart of FIG. 3.

When an audio signal of a song is input through the sound receiving unit 11 (S21), the sound processing unit 13 converts the audio signal into a frequency domain representation (S23).

The peak extractor 15a then extracts the first order harmonic peaks from the frequency domain representation (S25). Thereafter, the peak extractor 15a extracts up to nth order harmonic peaks on the basis of the first order harmonic peaks (S27).

When the order of harmonic peaks to be used is selected (S29), the harmonic feature producer 15b computes the harmonic feature based on the harmonic peaks of the selected order (S31). That is, the harmonic feature producer 15b computes the harmonic feature using Equation 1 or Equation 2. Selection of the peak order at step S29 can be made by the user through the input unit 18.

It is preferable to use harmonic peaks having an order that is higher than or equal to two. First order harmonic peaks are extracted from the frequency domain representation of an input audio signal, and hence can include a noise component or non-actual harmonic peak (dummy peak). Second or higher order harmonic peaks are extracted from the immediately lower order harmonic peaks, and hence a dummy peak in the immediately lower order harmonic peaks can be eliminated.

The harmonic component analyzer 15c identifies the input song through the harmonic component analysis on the basis of the computed harmonic feature (S33).

In the above procedure, the specific peak order to be used may be selected before the step S29 or be set by default.

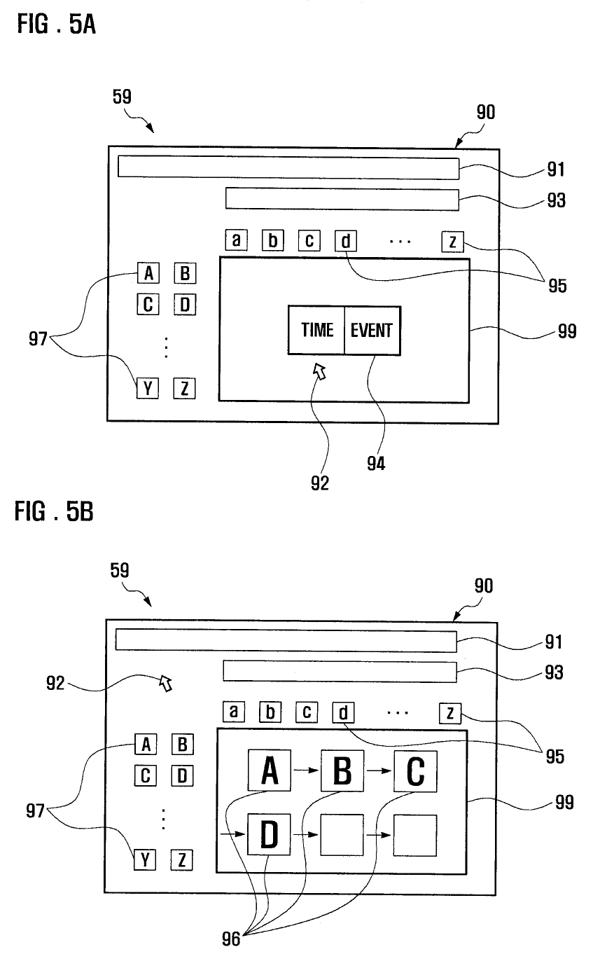

FIG. 4 illustrates a motion generation apparatus 50 based on music recognition for a mobile robot. The motion generation apparatus 50 includes a sound receiving unit 51, sound processing unit 53, control unit 55, memory unit 57, input unit 58, and a display unit 59.

The motion generation apparatus 50 can be implemented, for example, as a separate entity, or installed in a computer or physical mobile robot. The motion generation apparatus 50 can be connected to a virtual mobile robot, which is implemented as an avatar using software programs. In the following description, a mobile robot may comprise, for example, at least one of a physical mobile robot or a virtual mobile robot.

The sound receiving unit 51 receives an audio signal of a song and outputs the audio signal to the sound processing unit 53. The sound receiving unit 51 receives an audio signal of a song played by a music player such as a cassette player, CD player, MD player, MP3 player, computer, cellular phone, or radio. The sound receiving unit 51 can include, for example, a microphone or audio input terminal. The microphone receives an audio signal from a speaker of a music player. The audio input terminal receives an audio signal from a music player connected through a wired or wireless channel. The audio input terminal and music player can be connected together through an audio cable, or wirelessly through radio frequency communication or short-range communication like Bluetooth.

The sound processing unit 53 converts an audio signal from the sound receiving unit 51 into a frequency domain representation, and outputs the frequency domain representation of the audio signal to the control unit 55. This conversion can be performed, for example, using one of FFT, STFT, DFT, and DCT.

Still referring to FIG. 4, the control unit 55 preferably comprises a microprocessor for controlling the overall operation of the motion generation apparatus 50. In particular, the control unit 55 generates motions of a mobile robot or a motion script file therefore according to the audio signal of an input song.

The memory unit 57 stores programs necessary for the operation of the motion generation apparatus 50, and data generated from execution of the programs. The memory unit 57 includes one or more volatile and non-volatile memories. In particular, the memory unit 57 stores a motion generation program 57a for generating robot motions or a robot motion script file according to the audio signal of an input song, and a motion script file 57b generated by the motion generation program 57a.

The input unit 58 preferably includes a plurality of keys to manipulate the motion generation apparatus 50, and generates a key signal corresponding to a user-selected key and sends the key signal to the control unit 55. The user can issue a command through the input unit 58 to receive an audio signal through the sound receiving unit 51, to display an authoring tool screen 90 or execute the motion generation program 57a, or to display an extracted musical feature and final musical score on the authoring tool screen 90. The input unit 58 may include input means such as a mouse, key pad, touch pad, pointing device, and touch screen.

The display unit 59 displays various menus for functions executed by the motion generation apparatus 50, and information stored in the memory unit 57. In particular, the display unit 59 displays the authoring tool screen 90 necessary for generation of a motion script file. The display unit 59 can include a panel of LCD devices and a touch screen. The touch screen enables the display unit 59 to act as a display device and an input device at the same time.

In particular, the control unit 55 preferably includes a musical feature extractor 55a, musical score generator 55b, and motion generator 55c. The musical feature extractor 55a extracts a musical feature from an audio signal of an input song. The musical score generator 55b identifies the song on the basis of the extracted musical feature and generates an initial musical score, and generates a final musical score by synchronizing the initial musical score and musical feature together. The motion generator 55c matches the final musical score with a motion pattern of the mobile robot, and generates robot motions or a robot motion script file. The robot motion script file contains a final musical score for music output, and information on motions of the mobile robot.

The musical feature extracted by the musical feature extractor 55a includes at least one of interval information, meter information, beat information and harmonic information, for recognition of the input song. The harmonic information includes the harmonic feature described before.

The musical score generator 55b preferably generates in sequence an initial musical score and final musical score using the extracted musical feature.

The motion generator 55c can cause the mobile robot to move according to generated motions when the motion generation apparatus 50 is connected to the mobile robot. That is, when a song is input to the mobile robot, the mobile robot moves to the song under the control of the motion generator 55c. For example, the mobile robot can travel, rotate, or move the head, legs or arms according to the song. The motion generator 55c can generate robot motions as a robot motion script file.

A motion pattern can be provided to a mobile robot by default. A motion pattern includes a plurality of unit motions, each of which corresponds to an actual action executable by the mobile robot. For example, a unit motion can be a single action such as move forwards, move backwards, move left, move right, raise arm, lower arm, turn head left or turn head right, or a composite action composed of multiple single actions.

With continued reference to FIG. 4, the motion generator 55c can generate only a robot motion script file by matching a motion pattern with the final musical score. As described above, a motion pattern can be provided by default, or can be directly selected by the user through the authoring tool screen 90.

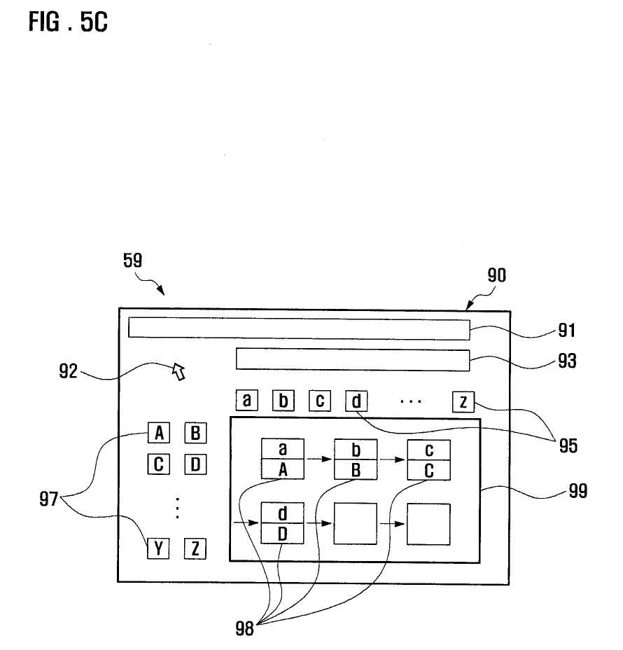

As shown in FIGS. 5A to 5C, musical feature items 95 associated with extracted musical features, include a score field 93 for a final musical score, and motion items 97 associated with motion patterns can be displayed on the authoring tool screen 90. When the user selects at least one of the motion items 97 necessary for robot motions through the input unit 58, the motion generator 55c creates a motion script file for an input song using motion patterns associated with the selected motion items 97.

A menu bar 91, including the musical feature items 95 associated with extracted musical features, the score field 93 for a final musical score, and a menu for motion script file creation, is displayed on the authoring tool screen 90. A task window 99 enabling motion script file creation by selecting the motion items 97 is displayed on the authoring tool screen 90. A notice window 94, requesting the user to select one of a time-based mode or event-based mode for motion patterns, can be displayed in the task window 99. The user can select an item displayed on the authoring tool screen 90 using the cursor 92 to invoke a desired function, and can move the cursor 92 through the input unit 58.

In FIGS. 5A to 5C, motion patterns are labeled by uppercase letters (A to Z), and musical features are labeled by lowercase letters (a to z).

In the time-based mode, when motion patterns, which are to be performed in order of time according to playback of a recognized song, are selected and arranged in the task window 99 as shown in FIG. 5B, the motion generator 55c (shown in FIG. 4) creates a motion script file using the selected and arranged motion patterns.

For example, when the time-based mode is selected through the notice window 94 displayed as shown in FIG. 5A, the motion generator 55c displays multiple task fields 96 in the task window 99 to arrange motion patterns as shown in FIG. 5B. The user selects motion patterns A, B, C and D through the input unit 58, and arranges them in the first four task fields 96. Then, when the user selects a menu item for script file creation in the menu bar 91 through the input unit 58, the motion generator 55c creates a motion script file using the arranged motion patterns A, B, C and D. In particular, if the display unit 59 has touch screen capability, the motion patterns can be arranged in the task fields 96 by dragging and dropping.

After the motion script file in the time-based mode is supplied to the mobile robot, the mobile robot makes motions corresponding to the motion patterns A, B, C and D in sequence when the song is played back.

In the event-based mode, when motion patterns and musical features are selected and matched together as shown in FIG. 5C, the motion generator 55c creates a motion script file using the motion patterns matched with the musical features. For example, when the event-based mode is selected through the notice window 94 displayed as shown in FIG. 5A, the motion generator 55c displays multiple task fields 98 in the task window 99 to match motion patterns with musical features as shown in FIG. 5C. The user selects musical features a, b, c and d and motion patterns A, B, C and D through the input unit 58, and matches the musical features a, b, c and d and the motion patterns A, B, C and D and arranges the matched ones in the first four task fields 98. Then, when the user selects a menu item for script file creation in the menu bar 91 through the input unit 58, the motion generator 55c creates a motion script file using the motion patterns A, B, C and D matched respectively with the musical features a, b, c and d. In particular, if the display unit 59 has a touch screen capability, motion patterns and musical features can be arranged in the task fields 98 by dragging and dropping.

After the motion script file in the event-based mode is supplied to the mobile robot, the mobile robot makes a motion corresponding to a motion pattern matched with a musical feature whenever the musical feature appears during playback of the song.

For example, when the musical feature b appears during playback of the song, the mobile robot makes a motion corresponding to the motion pattern B matched with the musical feature b.

Although the motion patterns A, B, C and D are arranged in the example illustrated in FIG. 5B, other motion patterns can also be arranged. Although the musical features a, b, c and d and the motion patterns A, B, C and D are matched together in FIG. 5C, other musical features and motion patterns can also be matched together. The authoring tool screen 90 in FIGS. 5A to 5C can be configured or modified in various ways.

Next, the motion generation method based on music recognition for a mobile robot is described in connection with FIGS. 4 to 7.

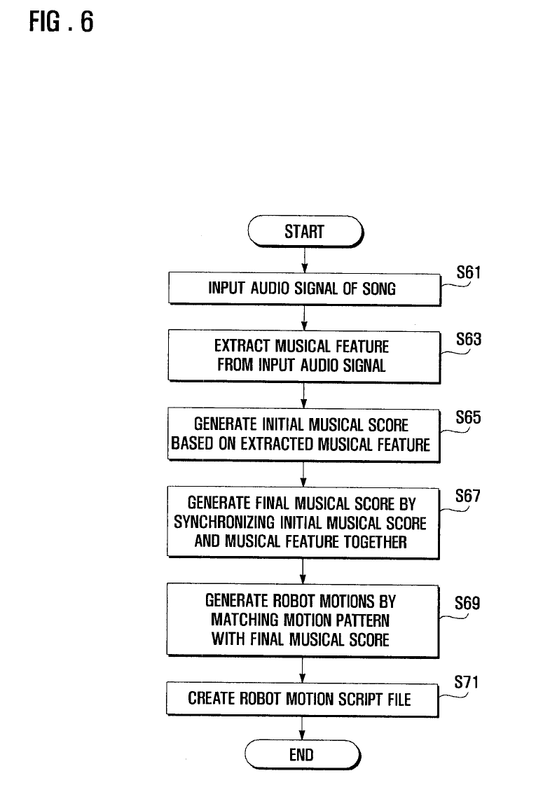

Referring to FIGS. 4 and 6, a first example of the motion generation method is described. In this case, the authoring tool screen 90 is not utilized, and the motion generation apparatus 50 is connected to the mobile robot.

With reference to the flowchart in FIG. 6, the sound receiving unit 51 of the motion generation apparatus 50 receives an audio signal of a song, and the sound processing unit 53 converts the audio signal into a frequency domain representation (S61).

The musical feature extractor 55a extracts a musical feature from the audio signal (S63). The musical feature extracted by the musical feature extractor 55a includes at least one of interval information, meter information, beat information and harmonic information, for recognition of the input song. The harmonic information includes the harmonic feature described before.

The musical score generator 55b identifies the song on the basis of the extracted musical feature and generates an initial musical score (S65), and generates a final musical score by synchronizing the initial musical score and musical feature together (S67).

The motion generator 55c generates robot motions by matching the final musical score with a motion pattern of the mobile robot (S69). For example, the motion generator 55c can generate robot motions by matching a motion pattern with a musical feature synchronized with the final musical score. The motion generator 55c causes the mobile robot to move using the generated motions. Hence, the mobile robot connected to the motion generation apparatus 50 moves to the input song.

The motion generator 55c creates a motion script file containing the generated robot motions (S71). The motion generator 55c can store the created motion script file in the memory unit 57.

In the above description, robot motions are generated by matching a motion pattern with the final musical score. Robot motions can also be generated, without use of the final musical score, by matching a motion pattern with a musical feature extracted from an audio signal of a song.

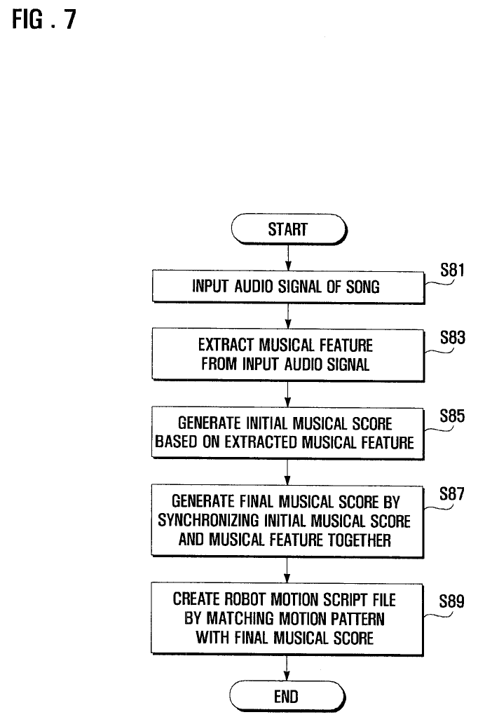

Next, referring to FIG. 4, FIGS. 5A to 5C, and the flowchart in FIG. 7, a second example of the motion generation method is described. In this case, the authoring tool screen 90 is utilized.

Steps S81 to S87 in FIG. 7 are identical to steps S61 to S67 in FIG. 6, and the description thereof is omitted. After generation of the final musical score, the motion generator 55c creates a motion script file by matching motion patterns with the final musical score (S89). Motion patterns can be provided by default, or can be directly selected by the user through the authoring tool screen 90. The user can select and arrange motion patterns in a time-based or event-based mode on the authoring tool screen 90 through the input unit 58.

As described above, the motion generation method (first example) can cause a mobile robot to move to an input song.

According to the present invention, the motion generation method (first and second example) can generate a motion script file causing a mobile robot to move to an input song. The generated motion script file can be used as a source for generating motions of another mobile robot. That is, when the motion script file is input to a mobile robot, the mobile robot can make a motion while producing sounds corresponding to the motion script file. When a song corresponding to the motion script file is input to a mobile robot, the mobile robot makes a motion according to the motion script file.

Although exemplary embodiments of the present invention have been described in detail hereinabove, it should be understood that many variations and modifications of the basic inventive concept herein described, which may appear to those skilled in the art, will still fall within the spirit and scope of the present invention as defined in the appended claims.

What is claimed is:

1. A music recognition method based on detecting harmonic data, comprising:
converting an audio signal of an input song into a frequency domain representation;
extracting first order harmonic peaks from the frequency domain representation, and also extracting up to nth order harmonic peaks (n: natural number greater than or equal to 2) being sequential to the first order harmonic peaks; and
computing a harmonic feature of the input audio signal associated with an average of distances between extracted harmonic peaks of the same order with respect to a first harmonic f₀ of the first harmonic peaks.

2. The music recognition method of claim 1, further comprising recognizing the input audio signal through harmonic component analysis based on the computed harmonic feature.

3. The music recognition method of claim 2, wherein the harmonic feature is computed by using the following equation:
$$\frac{1}{N - 1} {\sum }_{k = 1}^{N - 1} {( \frac{{p}_{k + 1} - {p}_{k} - {f}_{0}}{{f}_{0}} )}^{2} ,$$
wherein N is the number of harmonic peaks of a given order and pₖ is the kth harmonic peak.

4. The music recognition method of claim 2, wherein the harmonic feature is computed using the following equation:
$$\frac{1}{N - 1} {\sum }_{k = 1}^{N - 1} {( {A}_{k} )}^{γ} {( \frac{{p}_{k + 1} - {p}_{k} - {f}_{0}}{{f}_{0}} )}^{2} ,$$
where Aₖ is the amplitude of pₖ and γ is a constant.

5. The music recognition method of claim 3, wherein in extracting up to nth order harmonic peaks, the nth order harmonic peaks are extracted from a frequency domain consisting of the n−1th order harmonic peaks.

6. The music recognition method of claim 4, wherein in extracting up to nth order harmonic peaks, the nth order harmonic peaks are extracted from a frequency domain consisting of the n−1th order harmonic peaks.

7. The music recognition method of claim 5, wherein the harmonic feature is computed using second or higher order harmonic peaks.

8. A motion generation method based on audio recognition for a mobile robot, comprising:
extracting a musical feature from an input audio signal;
generating an initial musical score after identifying the input audio signal based on the extracted musical feature;
generating a final musical score by synchronizing the initial musical score and musical feature together; and
generating a plurality of robot motions by matching a motion pattern of the mobile robot with the final musical score.

9. The motion generation method of claim 8, wherein the musical feature comprises at least one of interval information, meter information, beat information and harmonic information of the input audio signal.

10. The motion generation method of claim 9, wherein the musical feature comprises harmonic information comprising a harmonic feature that is obtained by:
converting an input audio signal into a frequency domain representation;
extracting first order harmonic peaks from the frequency domain representation, and also extracting up to nth order harmonic peaks (n: natural number greater than or equal to 2) being sequential to the first order harmonic peaks; and
computing the harmonic feature associated with an average of distances between extracted harmonic peaks of a same order with respect to the first harmonic order.

11. The motion generation method of claim 10, wherein the motion pattern in generating robot motions is provided by default.

12. The motion generation method of claim 11, further comprising creating a motion script file containing the generated robot motions.

13. The motion generation method of claim 8, wherein the mobile robot is a physical mobile robot or a virtual mobile robot.

14. A motion generation method based on an audio signal recognition for a mobile robot, comprising:
extracting a musical feature from an input audio signal of;
generating an initial musical score after identifying the input audio signal on the basis of the extracted musical feature;
generating a final musical score by synchronizing the initial musical score and musical feature together; and
creating a motion script file by matching a motion pattern of the mobile robot with the final musical score.

15. The motion generation method of claim 14, wherein the musical feature comprises at least one of interval information, meter information, beat information and harmonic information of the input audio signal.

16. The motion generation method of claim 15, wherein the musical feature comprises at least harmonic information including a harmonic feature that is obtained by:
converting an input audio signal into a frequency domain representation;
extracting first order harmonic peaks from the frequency domain representation, and also extracting up to nth order harmonic peaks (n: natural number greater than or equal to 2) on the basis of the first order harmonic peaks; and
computing the harmonic feature related to an average of distances between extracted harmonic peaks of a same order with respect to the first harmonic.

17. The motion generation method of claim 15, wherein the motion pattern in creating a motion script file is provided by default.

18. The motion generation method of claim 15, wherein creating a motion script file is performed by using an authoring tool screen.

19. The motion generation method of claim 18, wherein the motion pattern comprises a plurality of unit motions.

20. The motion generation method of claim 19, wherein creating a motion script file comprises:
displaying the extracted musical feature, the final musical score, and motion items associated with motion patterns on the authoring tool screen; and
creating a motion script file by selecting and arranging motion items whose motion patterns are to be performed in order of time according to playback of the identified audio signal.

21. The motion generation method of claim 19, wherein creating a motion script file comprises:
displaying the extracted musical feature, the final musical score, and motion items associated with motion patterns on the authoring tool screen; and
creating a motion script file by matching selected ones of the motion patterns with at least one of the musical feature.

22. The motion generation method of claim 14, wherein the mobile robot comprises a physical mobile robot or a virtual mobile robot.
